(19) United States
(12) Patent Application Publication
(10) Pub. No.: US 2013/0003528 A1
(43) Pub. Date: Jan. 3, 2013

(54) JOINT NEAR-END AND FAR-END STATE MACHINE FOR SERVICE PROTECTION NETWORKS

(75) Inventors: Guoliang Wu, Plano, TX (US); Ladan S. Pickering, Plano, TX (US); Chenjiang Hu, Plano, TX (US); Si Long Ho, Allen, TX (US); David Traylor, Allen, TX (US); Rajnath Singh, Richardson, TX (US)

(73) Assignee: FUJITSU NETWORK COMMUNICATIONS, INC., Richardson, TX (US)

(21) Appl. No.: 13/175,580

(22) Filed: Jul. 1, 2011

(51) Int. Cl. H04L 12/26

(52) U.S. Cl. 370/220

(57) ABSTRACT

In one embodiment, a method for telecommunications includes determining the operational state of a first network switch, determining the operational state of a second network switch, determining the existence of an actionable condition, accessing information on the first switch, and changing the operational state of the first switch. The second network switch is coupled to the first network switch by a protected path. Determining the actionable condition and changing the operational state use references to the operational state of the first network switch, the operational state of the second network switch, and the actionable condition.

### TECHNICAL FIELD OF THE INVENTION

The present invention relates generally to networked communications and, more particularly, to a joint near-end and far-end state machine for service protection networks.

### BACKGROUND

In telecommunications, Ethernet linear protection switching under the G.8031 standard may establish protected paths for communication. With G.8031-type protected paths, two possible routes, one active and one backup, are preconfigured. The paths are monitored, and if one of the paths is detected as faulty, the backup path may take over and traffic continues to flow. Devices configured to handle G.8031-type protected paths may include transition tables based upon state machines that only take into account the state of the local device.

### SUMMARY

In one embodiment, a method for telecommunications includes determining the operational state of a first network switch, determining the operational state of a second network switch, determining the existence of an actionable condition, accessing information on the first switch, and changing the operational state of the first switch. The second network switch is coupled to the first network switch by a protected path. Determining the actionable condition and changing the operational state use references to the operational state of the first network switch, the operational state of the second network switch, and the actionable condition.

In another embodiment, an article of manufacture includes a computer readable medium and computer-executable instructions carried on the computer readable medium. The instructions are readable by a processor. The instructions, when read and executed, cause the processor to determine the operational state of a first network switch, determine the operational state of a second network switch, determine the existence of an actionable condition, access information on the first network switch, and change the operational state of the first switch based on the information. The second network switch is coupled to the first network switch by a protected path. The information includes the operational states of the first and second network switches and the actionable condition. Changing the operational state of the first switch is based upon the information associated with the operational states of the network switches and the actionable condition.

In yet another embodiment, a switch includes a computer readable medium, a transitional table stored in the computer readable medium, a processor coupled to the computer readable medium, and computer-executable instructions carried on the computer readable medium. The instructions readable by the processor, cause the processor to determine the operational state of the switch, determine the operational state of a far-end network switch, determine the existence of an actionable condition, access information in the table, and change the operational state of the switch based on the information. The far-end switch is coupled to the switch by a protected path. The information includes the operational states of the switch and the far-end switch and the actionable condition. Changing the operational state of the switch is based upon the information associated with the operational states of the switches and the actionable condition.

### BRIEF DESCRIPTION OF THE DRAWINGS

For a more complete understanding of the present invention and its features and advantages, reference is now made to the following description, taken in conjunction with the accompanying drawings, in which:

FIG. 1 is an example embodiment of a system including network devices in a service protection network;

FIG. 2 illustrates the operation of two network devices with different revertive mode configurations;

FIG. 3 is an illustration of an example use of transitional tables to consider states of both a near-end and far-end network device;

FIG. 4 is an illustration of another example use of transitional tables to consider states of both a near-end and far-end network device;

FIG. 5 is an example embodiment of a transitional table;

FIG. 6 is another example embodiment of a transitional table; and

FIG. 7 is an example embodiment of a method for using joint near-end and far-end state machines to facilitate communication in protected networks.

### DETAILED DESCRIPTION

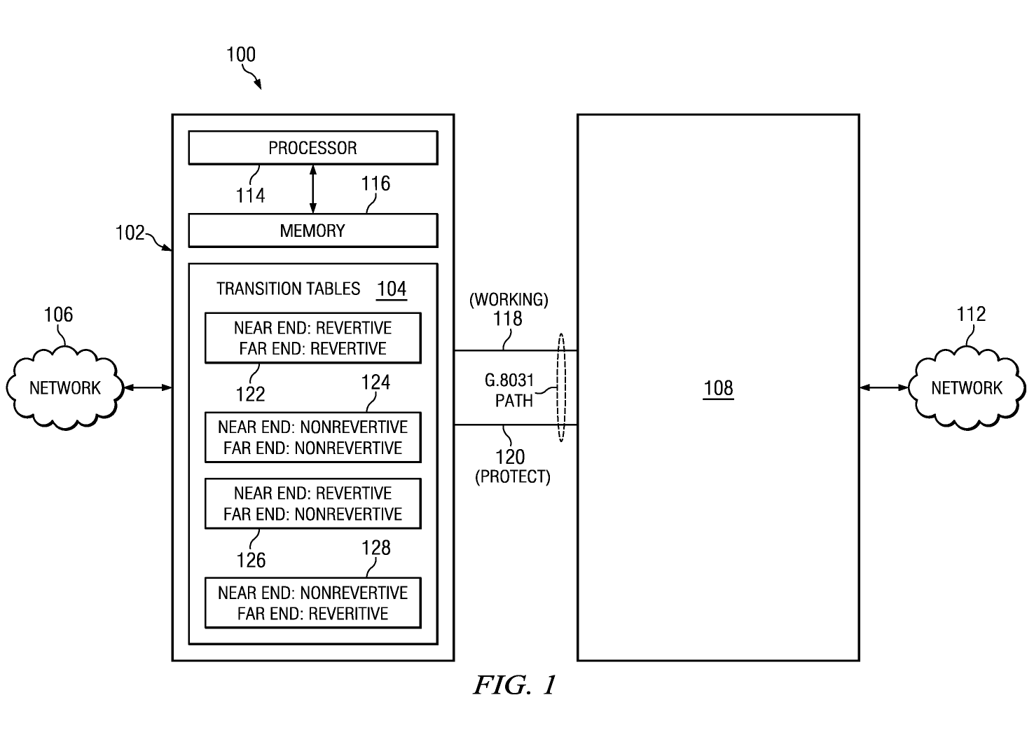

FIG. 1 an example embodiment of a system 100 including network devices in a service protection network. System 100 may include a network entity, such as switch 102 communicatively coupled to a network entity such as a second switch 108. In one embodiment, system 100 may be configured to provide routing of information in G.8031 service protection networks. In another embodiment, system 100 may be configured to route information using information regarding the states of both switch 102 and switch 108.

The network of system 100 may include switches 102, 108 coupled to other networks or sub-networks. In one embodiment, network 106 may be coupled to switch 102. In another embodiment, network 112 may be coupled to switch 108. Networks 106, 112 may comprise any suitable network—for example, a local-area-network, wide-area-network, a network of metro Ethernet switches, virtual-local-area-network, an intranet, or a portion of the Internet. System 100 may be configured to transport information between network entities coupled to switch 102 and network entities coupled to switch 108. Additional network entities may be coupled between switch 102 and switch 108. Such additional network entities may include a local-area-network, wide-area-network, a network of metro Ethernet switches, virtual-local-area-network, an intranet, or a portion of the Internet.

System 100 may be accessible by an operator at one or more portions of the network of system 100, such as switch 102. The operator may use interfaces of the system 100 to receive information regarding the operation of system 100 and to enter desired changes in system 100 in response to the information.

Switch 102 may include a processor 114 coupled to a memory 116. Processor 114 may comprise, for example, a microprocessor, microcontroller, digital signal processor (DSP), application specific integrated circuit (ASIC), or any other digital or analog circuitry configured to interpret and/or execute program instructions and/or process data. Switch 102 may interpret and/or execute program instructions and/or process data stored in memory 116. Memory 116 may comprise any system, device, or apparatus configured to hold and/or house one or more memory modules. Each memory module may include any system, device or apparatus configured to retain program instructions and/or data for a period of time (e.g., computer-readable media).

Switch 102 and switch 108 may include other network entities, not shown, which may be configured to carry on the communications described herein. Switch 102 and switch 108 may each contain multiple of such network entities. One example of such network entities may be a logical grouping of resources of the switch into a service group. The configuration and operations of switch 102 and switch 108 described here may be implemented in such logical groupings.

Switch 102 and switch 108 may communicate using linear protected switching. Switch 102 and switch 108 may be communicatively coupled through a linearly protected switching connection. The linearly protected switching connection may comprise a protected path. In one embodiment, the protected path may comprise a G.8031 protected path. Generally, the protected path may comprise a working path 118 and a protect path 120. Switch 102 and switch 108 may be communicatively coupled over working path 118 and protect path 120. One of paths 118, 120 may be designated as active, wherein a switch 102, 108 monitoring the paths 118, 120 for inbound traffic will accept packets from the active path and simply drop data packets from the other path, but still accept control packets required for the operation of a path protection protocol such as G.8031. In one embodiment, the working path 118 may be initially configured as the active path. If working path 118 is down or otherwise unavailable, then protect path 120 may be configured as the active path.

Each of working path 118 and protect path 120 may be routed through a number of network entities between switch 102 and switch 108. In one embodiment, each of working path 118 and protect path 120 may include two transmission media. Such transmission media may include any suitable media such as fiber or copper. Two of such transmission media may form a transmission tunnel and a reception tunnel for each switch 102, 108. One of paths 118, 120 may be designated as active, wherein a switch 102, 108 using paths 118, 120 for user traffic will transmit and receive packets making up the user traffic over the active path, but ignore such user traffic on the other path. User traffic may include user traffic originating and travelling to destinations in network 106 and network 112. User traffic may flow on working path 118 or protect path 120, depending upon the configuration of switches 102 and 108. Such a configuration may determine which of the paths is active and thus carrying user traffic. The switch may continue to monitor the protect path 120 for control and status messages, such as automatic protection switching (“APS”) messages. Switch 102 and switch 108 may be configured to periodically exchange APS messages. Such messages may be exchanged one-for-one, and in both directions. Such APS messages may contain information pertaining to the status, state, and operation of a switch to be communicated to another switch.

APS messages may be exchanged using the protect path 120. In one embodiment, the working path 118 may be initially configured as the active path. If working path 118 is down or otherwise unavailable, then protect path 120 may be configured as the active path for user traffic. In another embodiment, switch 102 and switch 108 may exchange user traffic over the active path, but only exchange APS messages over protect path 120. In such an embodiment, if protect path 120 is unavailable then APS messages may be lost. APS messages and user traffic may thus be able to be transmitted at times on the same protect path 120. System 100 may thus be configured to transport user traffic between various networked entities in system 100, such as between those in network 106 and in network 112. Switches 102, 108 may be configured to operate in pre-determined states of operation, depending upon the conditions encountered. Pre-determined states of operation may indicate any suitable information about operational settings or conditions encountered. For example, pre-determined states of operation may indicate to switches 102, 108 which path 118, 120 should be used for communication given the occurrence of a particular event.

Switches 102, 108 may include one or more transitional tables 104. Transitional tables 104 may include information indicating pre-determined states of operation for which switches 102, 108 may use to determine a course of action given a particular condition. Transition tables 104 may include any suitable number of pre-determined states. Transition tables 104 may contain indications, for each state, of what actions should be taken given any number of conditions observed. Transition tables 104 may be stored in memory 116. Transition tables 104 may be implemented as a record, file, or any other suitable data structure. Transition tables 104 may be implemented, for example, as a single table, or a table of tables. For example, transition tables 104 may include tables 122, 124, 126, 128, discussed in further detail below.

For a given switch, the switch may have an indication of the status of the switch. For example, switch 102 may include one or more of the following states:

“A”—indicating of normal operation wherein communication with other switches (such as switch 108) is conducted on working path 118 with protect path 120 on standby.

“B”—indicating an operation wherein communication between switches is conducted on protect path 120 with working path 118 on standby.

“C”—indicating a lockout of normal traffic signals.

“D”—indicating a forced switch command has been issued to select traffic from the protect path 120.

“E”—indicating that an error has occurred while communicating on the working path 118.

“F”—indicating that an error has occurred while communicating on the protect path 120.

“G”—indicating a manual switch command has been issued to select traffic from the protect path 120 in the absence of a failure.

“H”—indicating that traffic will be selected from the protect path 120 until a wait-to-restore timer expires.

“I”—indicating an EXER command has been issued to test if communications are operating correctly.

“J”—indicating either an EXER command has been issued or a reverse command has been issued to reverse a previous command.

“K”—indicating that a reverse command has been issued to reverse a previous command.

Switch 108 may similarly have one or more of the above example states. A state may reference the status of a given switch such as switch 102 or switch 108 from the perspective of the switch itself. In one embodiment, such states may thus describe the status of a single switch, but not other switches. Switch 102 may learn of the status of switch 108 through, for example, APS messages received from switch 108.

Transition table 104 may include state indications of the switch 102 on which it resides together with state indications of one or more other switches, such as switch 108. Transition table 104 may include any suitable indication of the combined statuses of switches 102, 108, including pairs of the states as described above. From the perspective of transition table 104, switch 102 may be considered “near-end” and switch 108 may be considered “far-end.” Thus, the states described in transition table 104 may be in regard to a near-end state and a far-end state. In one embodiment, such a near-end state may refer to the status of switch 102 and such a far-end state may refer to the status of switch 108.

Transition table 104 may implement a joint near-end and far-end state machine for switch 102. Such a joint near-end and far-end state machine may include both the state of switch 102 and the state of one or more other network devices, such as switch 108. Thus, the transitions detailed in transition table 104 and subsequently taken by switch 102 are made considering the status of switch 102 and, for example, switch 108.

For a given set of states indicating the status of switch 102 and another switch to which switch 102 is communicatively coupled—such as switch 108—transition table 104 may include information regarding subsequent action that is to be taken. Such action may include any suitable action to be performed by switch 102. Such action may include an indication of another state into which switch 102 will enter, thus reflecting a changed status of switch 102.

Network 100 may utilize 1:1 linear protection as implemented by switch 102 and switch 108. In such a case, user traffic may be transmitted on either part of a protected path, such as working path 118. However, user traffic may not be transmitted on both sides of the path, such as on both working path 118 and protect path 120. If one of switches 102, 108 attempts to transmit user traffic on working path 118 and the other attempts to transmit user traffic on protect path 120, both switches will not receive the other end's traffic, and the traffic may be lost. Switch 102 may be configured to utilize information in transition tables 104 to determine, given any state of switch 102 and switch 108, what actions to take to maintain communications with switch 108.

Upon detection of a loss in user traffic, switch 102 may be configured to switch to a different pre-determined state of operation based upon the conditions encountered, the configuration of switch 102, and the information included in transition tables 104. Transition tables 104 may include, for example, directives that switch 102 move user traffic to an alternative path under certain conditions or states. For example, if switch 102 and switch 108 are communicating user traffic over working path 118 and communication over the working path 118 fails, upon detection or notification of the failure, switch 102 may enter a state such as “E.” State “E” may be utilize APS signaling of “SF r/b=normal” wherein the working path is set as a standby and the protect path is set as active. Thus, switch 102 may be configured to move user traffic to protect path 120. Assuming switch 108 is similarly configured, switch 108 may move user traffic to protect path 120 as well.

Switches such as switch 102 or switch 108 may be configured in a revertive mode or a non-revertive mode. Switch 102 configured in revertive mode may, after switching to protect path 120, automatically return to working path 118 after such working path 118 returns to an available status or state, after waiting a designated period of time. Conversely, after switching to a protect path such as 120, switch 102 configured in nonrevertive mode may be configured to remain in protect path 120 even after working path 118 returns to an available status or state.

The mode—revertive or nonrevertive—may be configured for an individual switch 102 or 108 on a per-device basis. Such a configuration may arise from direct user action, wherein a user of switch 102, 108 sets the revertive/nonrevertive mode directly. Such a configuration may also arise from a received command from another network device, as a setting upon start-up or upon another condition, or from any other feasible source.

In some cases, the failure of a network device such as switch 102 to take into account the state or statuses of other network devices such as switch 108 may lead to problems in service protection networks. Such failures may arise from, for example, a lack of information in transition tables 104 concerning the state of switch 108. In one embodiment, such a failure to account for the state or statuses of other network devices may include a failure to account for the revertive or nonrevertive configuration of the network devices.

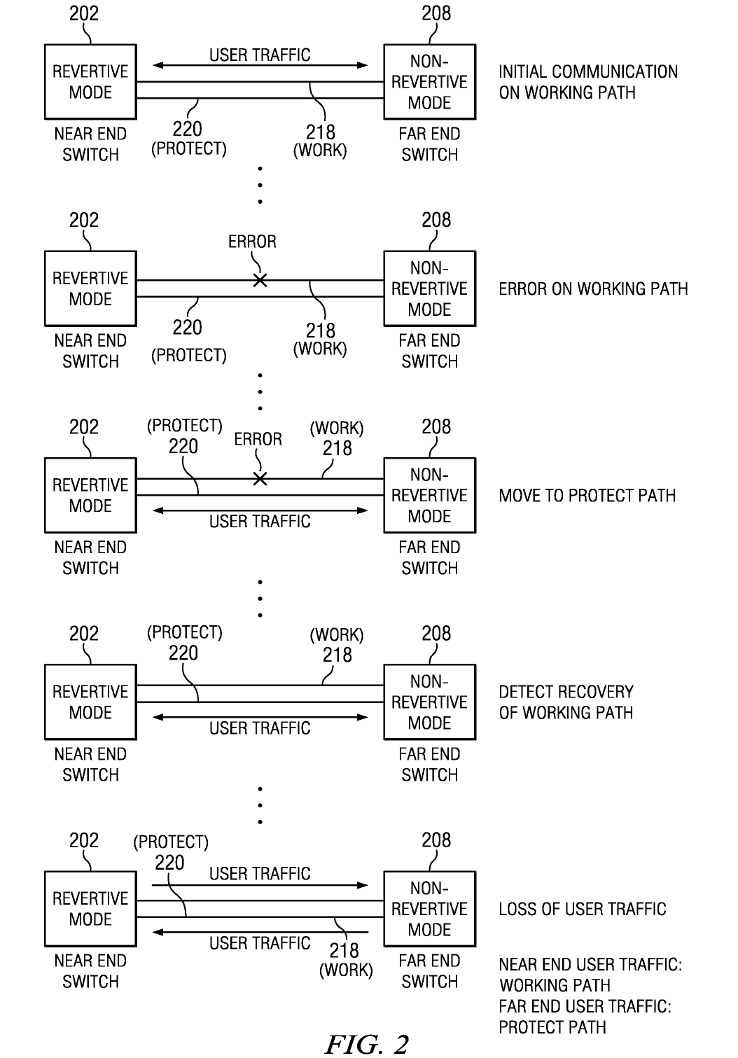

For example, FIG. 2 illustrates the operation of two network devices such as switch 202 and switch 208 with different revertive mode configurations wherein each switch considers only its own operational state. Switch 202 (i.e. the near-end switch) may be configured in revertive mode and switch 208 (i.e. the far-end switch) may be configured in nonrevertive mode. Initially, communication of user traffic may occur over working path 218 until an error arises on working path 218. At such a point, switch 202 and switch 208 may be configured to move user traffic to protect path 120. Upon detection of the recovery of working path 118, switch 202 in revertive mode may be configured to revert to sending user traffic over working path 118. Such a configuration may be the result of considering switch 202's status, and not considering the status of other network devices such as switch 208. Switch 208, working in nonrevertive mode, may be configured to maintain sending user traffic on protect path 120. Because switch 202 failed to consider the state of switch 208, the communication of user traffic may be interrupted as switch 202 sends user traffic over working path 118 while switch 208 sends user traffic over protect path 120.

The operation illustrated in FIG. 2 is one example of inefficiencies, errors, or other problems that may arise by network devices failing to consider the status or state of other network devices in the service protection network. While switches in service protection networks may be provisioned with matching revertive or nonrevertive modes, such modes may be changed by users, commands, or default settings upon reboot or device crashes, leading to such problems.

Returning to FIG. 1, transitional tables 104 may include information about the status or states of the near-end switch (such as switch 102) and one or more far-end switches (such as switch 108). Transitional tables 104 may contain information about prescribed actions to take—and subsequent states to enter—given a set of states of the near-end and far-end switches, and given an observed condition. Thus, transitional tables 104 may implement a joint-status state machine. Transitional tables 104 may provide a picture of the operational status of the system 100 beyond an individual network device. Transitional tables 104 may conform to the near-end state machine of the G.8031 standard and include additional scenarios that take into account the status of far-end devices.

Transitional tables 104 may include any suitable information for providing alarms, APS messaging, or state transitioning of near-end and far-end devices. In one embodiment, transitional tables 104 may include separate tables for various near-end and far-end revertive configurations. For example, transitional tables 104 may include a table 122 wherein both near-end and far-end devices (e.g. switches 102 and 108) are configured to be revertive; table 124 wherein both near-end and far-end devices are configured to be nonrevertive; table 126 wherein the near-end device is configured to be revertive and the far-end device is configured to be nonrevertive; and table 128 wherein the near-end device is configured to be nonrevertive and the far-end device is configured to be revertive. In another embodiment, transitional tables may incorporate information from one or more of tables 122, 124, 126, and 128 into a single table.

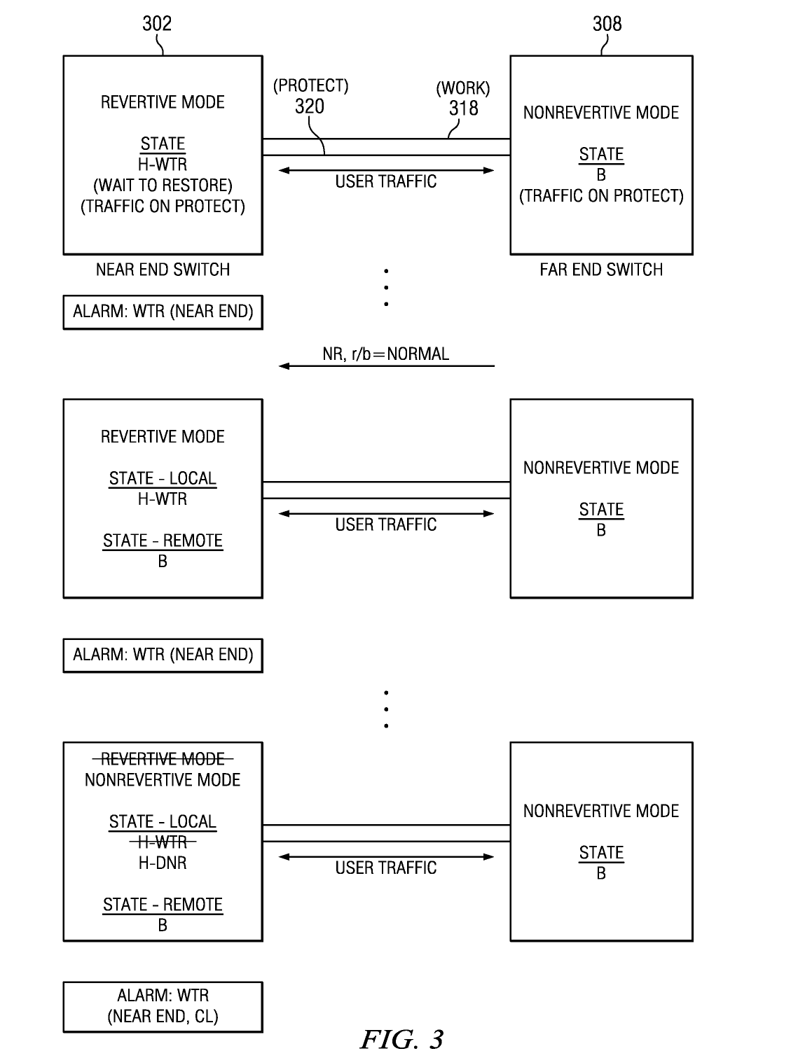

FIG. 3 is an illustration of an example use of transitional tables 104 to consider states of both a near-end and far-end network device. Switch 302 and switch 308 may be communicatively coupled over working path 318 and protect path 320. Switch 302 may contain a transitional table to take into account the state of switch 308 for use by switch 302 to take appropriate actions given a condition. For example, switch 302 may be in revertive mode and switch 308 may be in nonrevertive mode. Switch 308 may be in state “B,” and switch 302 may be in state “H-WTR.” Accordingly, communication of user traffic may be occurring on protect path 320. However, in the present mode of operation switch 302 may only be temporarily communicating user traffic on protect path 320, as it is waiting to revert communication back to working path 318. Switch 308 may communicate its current status and mode through an APS message. Such a message may indicate “NR r/b normal,” meaning that switch 308 is in nonrevertive mode and is communicating normally on the protect path.

Switch 302 may contain transitional tables for each revertive-nonrevertive combination of itself and switch 308, such as illustrated in FIG. 1. Switch 302 may contain a transitional table such as table 126, wherein switch 302 (the near-end switch) is revertive but switch 308 (the far-end switch) is nonrevertive. In one embodiment, switch 308 may contain analogous or complementary transitional tables, including a transitional table such as table 128, wherein switch 308 (the near-end switch) is nonrevertive but switch 302 (the far-end switch) is revertive. In such an embodiment, the tables of switch 302 and switch 308 may be configured to guide their respective switches to correctly communicate. The table of switch 302 may take into account the status of switch 308, and vice-versa, so that the switches may not take actions inconsistent with the operation of the other switch. In the example of FIG. 3, switch 308 may have no such table and may proceed as if it does not take into account the status of switch 302, or switch 308 may have such a table which indicates that the near-end switch (switch 302) will adjust to meet the state of switch 308. In the example of FIG. 3, switch 302 may contain a table with information on how, given its state and the state of switch 308, it will act to configure itself to work correctly with switch 308.

For example, after receiving the status message “NR r//b normal” from switch 308 indicating that switch 308 is in nonrevertive and communicating user traffic through the protect path, switch 302 may be configured to access a transitional table matching near-end-revertive-mode, far-end-nonrevertive-mode, such as table 126 of FIG. 1. Such a table may instruct switch 302 on what subsequent actions to take. Such subsequent actions might include, for example, switching its own state, switching its own mode, setting an alarm, or taking any other suitable action to be compatible with the state of switch 308, or a state which switch 308 will subsequently occupy.

In FIG. 3, switch 302 may set an alarm that the far-end network device is in nonrevertive (“DNR”) mode. Switch 302 may determine that it will be in an incompatible mode with switch 308 because after a period of time, switch 302's revertive mode will dictate that switch 302 move user traffic to the working path 318, while switch 308 will expect such traffic on the protect path 320. This may be because switch 302 is currently in “H-WTR” mode, wherein it is communicating user traffic over protect path 320 but is waiting to switch to the working path 318. To avoid such a problem, switch 302 may switch its own mode to nonrevertive mode. Switch 302 may move to state “H-DNR,” wherein it is waiting for the working path 318 to recover, but it will not move communication to working path 318 from protect path 320. Switch 302 may also clear the alarm that the far-end device, switch 308, is in nonrevertive mode.

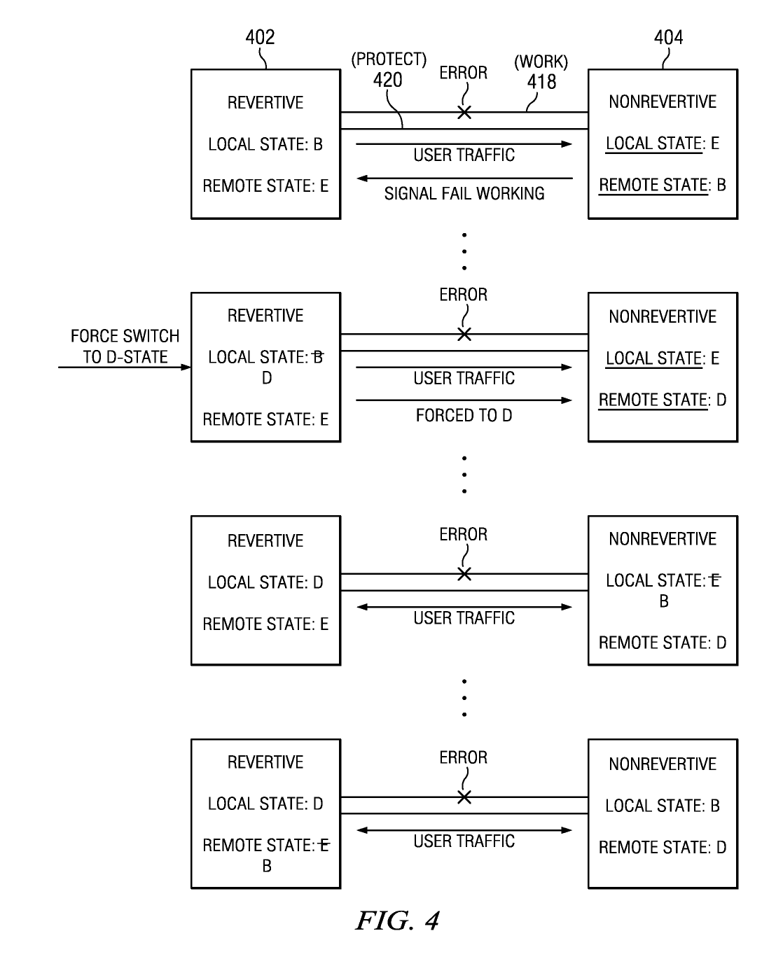

FIG. 4 is an illustration of another example use of transitional tables 104 used to consider states of both a near-end and far-end network device. Switch 402 may be in “B” state, communicating user traffic over the protect path 420, while switch 408 may be in “E” indicating an error in the working path 420, which it is communicating to switch 402. Meanwhile, switch 402 may receive a command forcing it to move to the “D” state, In response and in order to communicate with switch 402, switch 408 may be configured, using a transitional table such as transitional table 104, to move to state “B” and communicate user traffic on the protect path 420. By detecting the command forcing all traffic to protect path, switch 402 may appropriately match the operation of switch 408.

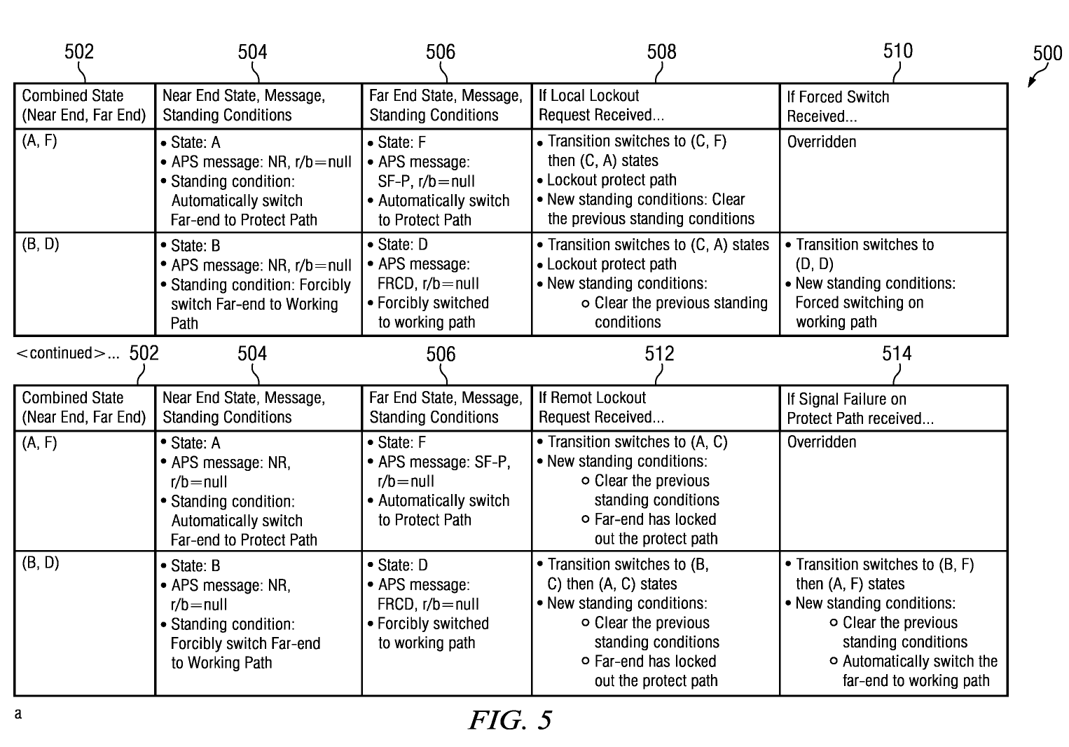

FIG. 5 is an example embodiment of a transitional table 500. Transitional table 500 may implement one or more of tables 122, 124, 126, 128 or 104 of FIG. 1. Transitional table 500 may include an index 502 field, containing an indication of a state of a near-end network device and an indication of a state of one or more far-end network devices. In FIG. 5, two such indices are shown: (A, F) and (B,D), indicating entries for when the near-end switch is in state “A” and the far-end switch is in state “F;” and for when the near-end switch is in state “B” and the far-end switch is in state “D.” Furthermore, for each state-pair additional descriptions of the conditions associated with each state may be shown in fields 504 and 506. Near-end conditions 504 indicate what APS messages, alarms, standing conditions, or other information may accompany the near-end switch. Far-end conditions 506 indicate what APS messages, alarms, standing conditions, or other information may accompany the far-end switch.

Transitional table 500 may include a variety of conditions for which state transitions may be provided. For example, transitional table 500 is shown with transitions defined for conditions such as local lockout 508, forced switch 510, remote lockout 512, and signal-failure on protect path 514. Any suitable number of conditions may be included in transitional table 500. Such conditions may include alarms, messages, input from users, failures, errors, or any other suitable factor.

For example, if the two switches (near-end, far-end) are in states (A, F), and a local lockout request 508 is received, then the switches may be transitioned to states (C, A). In one embodiment, the switches may be first transitioned to states (C, F). Commands for locking out the protect path may be issued. Previously issued standing conditions, such as automatically switching the far-end to the protect path, may be cleared. In the same such initial condition of (A, F), if a forced switch command is received, such a command may be overridden, or ignored If a remote lockout request 512 is received, the switches may be transitioned to (A, C). In such a case, the standing condition may indicate that the lockout was remotely initiated. If signal failure on the protect path 514 is received, then the switches may be overridden, as communication is being conducted already on the working path, and the present states maintained.

In another example, if the two switches are in states (B,D) and a local lockout request 508 is received, the switches may be transitioned to states (C, A) and the protect path locked out. If a forced switch 510 is received, then the switches may be transitioned to states (D, D), indicating a forced switch to the working path. If a remote lockout request 512 is received, then the switches may be transitioned to (B, C) then (A, C) and a standing condition issued that the far-end has locked out the protect path. If a signal failure on the protect path is received, then the switches may be transitioned to (B, F) then (A, F).

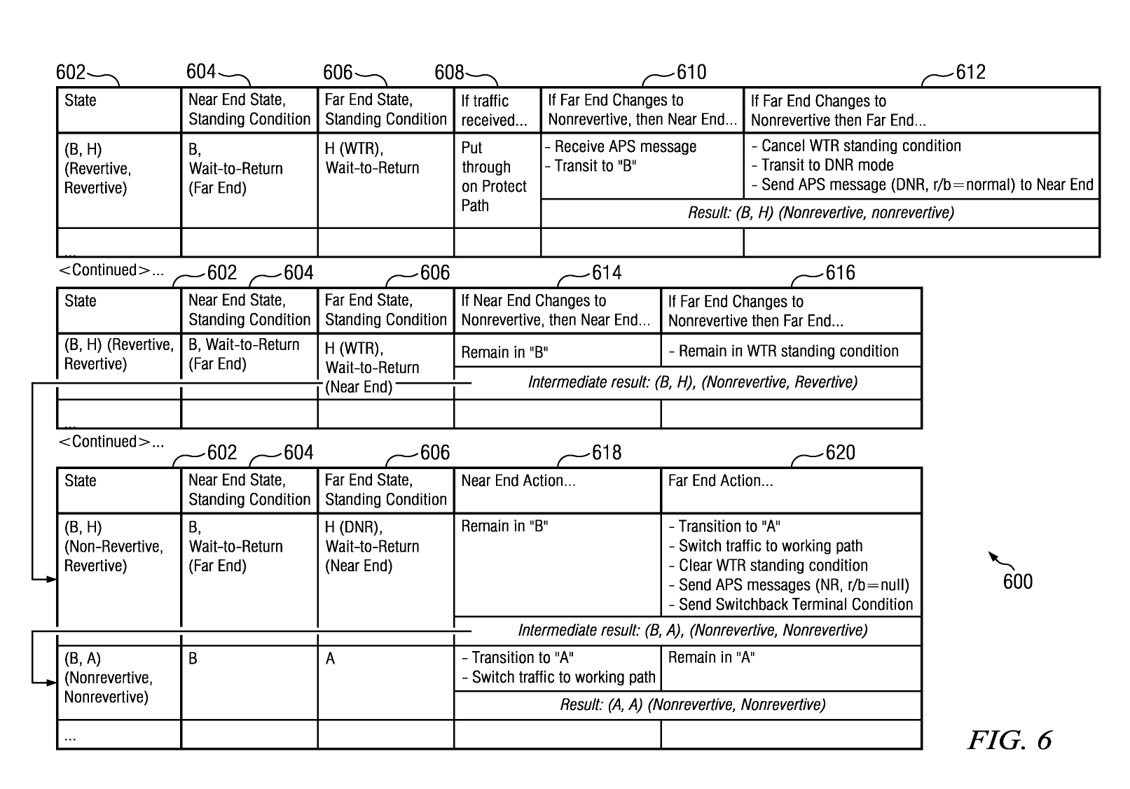

FIG. 6 is another example embodiment of a transitional table 600. Transitional table 500 may implement one or more of tables 122, 124, 126, 128 or 104 of FIG. 1. For example, transitional table 600 may contain entries for revertive-revertive, nonrevertive-revertive, revertive-nonrevertive, and/or nonrevertive-nonrevertive state pairs. In various embodiments, such paired modes may be implemented in separate transition tables, although they are shown together in FIG. 6 for the sake of clarity. FIG. 6 may demonstrate the implementation of a state machine for detecting changes in revertive mode and subsequent handling of the changes to continue to facilitate transmission of user traffic.

Transitional table 600 may include indices indicating the state 602. In one embodiment, the state 602 may be given by a pair of states reflecting a pair of switches, such as a near-end switch and a far-end switch. For example, (B, H) may indicated that the near-end-switch is in state “B” and the far-end switch is in state “H.” Such an indication may be made from the perspective of a specific switch, and implemented as such within the specific switch's transitional table. Within the transitional table of the far-end switch is this example, the same pair may be represented as (H, B). In another embodiment, near-end switch may be implemented by switch 102 and far-end switch may be implemented by switch 108 of FIG. 1. State 602 may indicate or contain information regarding the revertive mode of each of the switches (e.g., (Revertive, Revertive). In one embodiment, such an indication may be made by designating an entire table as representative of a particular combination of modes, such as both switches being in revertive mode. Such entire tables may be implemented by, for example, tables 122, 124, 126 or 128. In another embodiment, information for the particular combination of modes may be listed with the state 602 index, wherein multiple entries for the state (e.g., (B, H)) will exist, each paired with a different combination of revertive modes (e.g., (Revertive, Revertive), (Nonrevertive, Revertive)).

Transitional table 600 may include an indication of the near end state 604 and an indication of the far end state 606, which may indicate the state as well as any standing conditions such a state is operating under. Transitional table 600 may include designations of what actions are to be taken by either the far end, near end, or both, given various actions. Such actions may include those discussed in the context of transitional table 500. In one embodiment, transitional table 600 may include designations 608 for received traffic, designation 610 for the near-end if the far-end changes to nonrevertive mode, designations 612 for the far-end if the far-end changes to nonrevertive mode, designations 614 for the near-end if the near-end changes to nonrevertive mode, or designations 616 for the far-end if the near-end changes to nonrevertive mode. In other embodiments, transitional table 600 may include designations 618 for actions to be taken by the near-end switch or designations 620 for action to be taken by the far-end switch. Such designations might not have a additional predicate basis other than the present occurrence of the particular operational state 602.

For example, a system using transitional table 600 may have two switches initially in a (B, H) state, wherein both switches are in revertive mode. As illustrated in column 604 for the (B, H) state, the near-end switch may be in the “B” state and may be aware that the far-end switch is in a wait-to-return condition. The far-end switch may be in the “H” state, in a wait-to-return standing condition. In such a case, if user traffic is received according to designation 608, it is communicated over the protect path.

However, if the far-end switch changes to nonrevertive mode, transitional table 600 may be configured to provide information for system 100 to appropriately handle the potential mismatch of modes. The near-end switch may be configured by designation 610 to wait to receive an APS message from the far-end, and then transition to state “B.” The far-end switch may be configured by designation 612 to cancel the wait-to-return standing condition, transition to do-no-return mode, and send an APS message to the near-end switch. The APS message may contain (DNR, r/b=normal). Consequently, the switches may be in the state (B, H) (Nonrevertive, Nonrevertive).

In another example, given the same state entry 602 corresponding to the initial state (B, H) (Revertive, Revertive), the near-end may change to nonrevertive mode. Consequently, designation 614 may configure the near-end switch to remain in state “B” and configure the far-end switch to remain in state “H” with WTR standing condition. Thus, resultant state may be (B, H) (Nonrevertive, Revertive). In one embodiment, this resultant state may be intermediate, as such a state may still lead to communication problems. Another state 602 entry of transitional table 600 may correspond to this intermediate state. In such a case, designation 618 may configure the near-end switch to remain in state “B.” Designation 620 may configure the far-end switch to take several steps such as transitioning to state “A,” switching traffic to working path, clearing existing wait-to-restore standing conditions, sending the APS message (NR, r/b=null) to the near-end switch, and sending a switchback terminal condition. Such a switchback terminal condition may instruct the near-end switch that the far-end switch is switching back to the working path. Consequently, the switches may enter a state corresponding to (B, A) (Nonrevertive, Nonrevertive). In one embodiment, this resultant state may be intermediate, as such a state may still lead to communication problems. Another state 602 entry of transitional table 600 may correspond to this intermediate state. In such a case, designation 618 may configure the near-end switch to transition to state “A” and switch traffic to working path. Designation 620 may configure the far-end switch to remain in state “A.”

In operation, system 100 may be executing to transfer user traffic between destinations within the networks contained in or communicatively coupled to system 100. Switch 102 may share APS messages over protect path 120 with switch 108, and may route user traffic over protect path 120 or working path 118, depending upon the operational state of switch 102 and switch 108. Switch 102 may be operating in revertive or nonrevertive mode. Switch 102 may maintain information regarding the operational state of switch 108 based upon information received from switch 108. In one embodiment, switch 108 may not be similarly maintaining information regarding the operational state of switch 102. In another embodiment, switch 108 may be maintaining similar information regarding the operational state of switch 102. Upon reception of an instruction, alarm, condition, signal, or other indication of a changed condition, switch 102 may consult one or more transitional tables 104 to determine a course of action to take. Switch 102 may select a transitional table 104 to use based upon the revertive or nonrevertive configuration of switch 102 or switch 108.

Switch 102 may take the actions specified in the joint state machine embodied in transitional table 104, 500, and/or 600. Such actions may include setting conditions, warnings, alarms, or other instructions. The actions specified may indicate to which operational states switch 102 and switch 108 should transition. Switch 102 may communicate such actions to be taken to switch 108. In embodiments wherein switch 108 contains similar transition tables, switch 108 may be configured to move to specified operational states at its own direction. In one embodiment, the revertive or nonrevertive configuration of switches 102 and 108 may be changed to match one another. Upon entering a new state of operation, switch 102 may be configured to again consult its transitional table 104 upon receipt or determination of another condition.

Switch 102 may access transitional tables to determine a course of action to take given the known states of switch 102, switch 108, and other suitable information. In one embodiment, switch 108 may access transitional tables without the capabilities of joint near-end and far-end state machines. Such an embodiment may include situations wherein switch 108 is not controlled by the same user, organization, or entity as switch 102, and consequently switch 108 may not be provisioned with transitional tables with joint near-end and far-end state machines. In such an embodiment, switch 102 may access transitional tables to meet the expected behavior of switch 108. Such expected behavior may include, for example, default behavior of a switch using the G.8031 protocol.

In another embodiment, switch 108 may access transitional tables with joint near-end and far-end state machine capabilities. In such an embodiment, switch 108 and switch 102 may act simultaneously to reach states of operation that facilitate communication of user traffic.

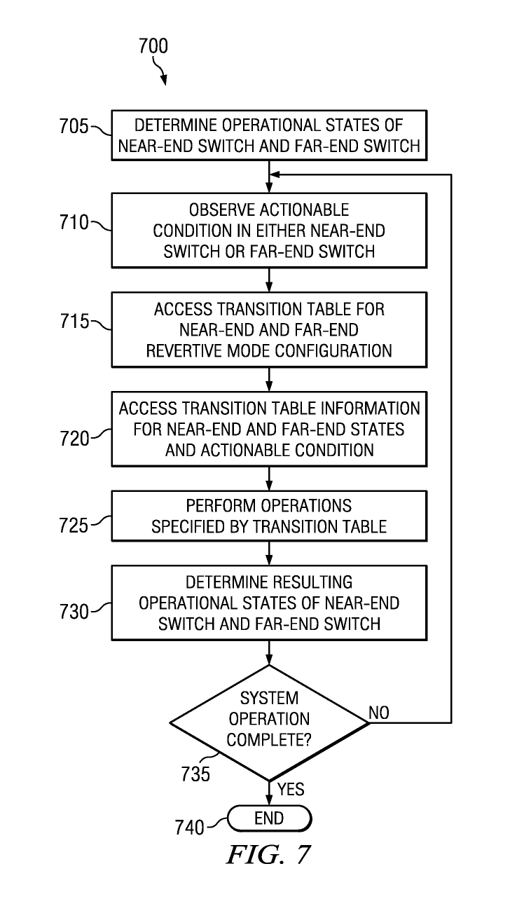

FIG. 7 is an example embodiment of a method 700 for using joint near-end and far-end state machines to facilitate communication in protected networks. During electronic communication, in step 705 the operational state of a near-end switch and a far-end switch may be determined. Such an operational state may include a state in a state machine, standing or terminal conditions, and/or configuration as revertive or nonrevertive. The operational state of a far-end switch may be determined by messages received from the far-end switch. In one embodiment, the messages by which the far-end switch operational state is determined may include APS messages.

In step 710, an actionable condition in either the near-end switch or far-end switch may be observed. Such actionable conditions may include but are not limited to messages, alarms, notifications, user input, observed mismatched configurations such as mismatched revertive modes between the near-end switch and far-end switch, or any other suitable criteria. Such actionable conditions may include a condition for which an entry in a joint near-end and far-end state machine has been defined. Such a state machine may be implemented by one or more transition tables. Such entries may include an action specific to the near-end switch and/or the far-end switch.

In step 715, such a transitional table or other implementation of a joint near-end and far-end state machine may be accessed according to the respective revertive modes of the near-end switch and far-end switch. In one embodiment, separate tables may be accessed for different combinations of respective revertive modes. In another embodiment, a table may contain state machine information for more than one revertive mode configurations.

In step 720, the contents of a transition table or other implementation of a joint near-end and far-end state machine may be accessed. Such contents may instruct the operation of, for example, the near-end switch. In one embodiment, the contents may be indexed by the state of the near-end switch and the far-end switch. In another embodiment, the contents may be indexed by standing conditions and/or terminal conditions of the system or switch. In yet another embodiment, the contents may be accessed by making reference to the observed actionable condition. The entry or entries in the transition table may be read.

In step 725, the operations specified by the entries in the transition table may be carried out. Such operations may include but are not limited to transitioning the near-end switch to another state; instructing the far-end switch to transition to another state; changing the configuration mode of the near-end switch or instructing the far-end switch to change its configuration mode, setting or changing initial or terminal conditions, or sending APS messages to the far-end switch. Messages or replies may be observed coming from the far-end switch. In step 730, the operational states of the near-end switch and far-end switch may be determined. Step 730 may be implemented in similarly to step 705. The operational states may indicate that the system is to be shut down. In step 735, it may be determined whether the system is to be shut down, and if so in step 740 the method may terminate. If the system is not designated to be shut down, then the method may repeat starting again at step 710.

Method 700 may be conducted with respect to an individual switch in a protected network. In one embodiment, method 700 may be conducted at the same time with another switch in communication with the first switch. By way of transition table information, method 700 may be adjusted if method 700 is to be conducted simultaneously on two different switches. Such adjustments may include the ability to direct the operation of the two switches towards a desired state, rather than simply directing the operation of a single switch to adjust itself to reach the desired state.

The steps of method 700 may be conducted in parallel by different entities implementing method 700.

Although FIG. 7 discloses a particular number of steps to be taken with respect to an example method 700, method 700 may be executed with more or fewer steps than those depicted in FIG. 7. In addition, although FIG. 7 discloses a certain order of steps to be taken with respect to method 700, the steps comprising method 700 may be completed in any suitable order.

Method 700 may be implemented using the system of FIGS. 1 and 3-6 or any other system, network, or device operable to implement method 700. In certain embodiments, method 700 may be implemented partially or fully in software embodied in computer-readable media.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as non-transitory media; and/or any combination of the foregoing.

Although the present disclosure has been described in detail, it should be understood that various changes, substitutions, and alterations can be made hereto without departing from the spirit and the scope of the disclosure as defined by the appended claims. For example, in some embodiments the operations of switch 102 may also be conducted by switch 108, and vice-versa.

What is claimed is:

1. A method for telecommunications, comprising:
determining the operational state of a first network switch;
determining the operational state of a second network switch, the second network switch coupled to the first network switch by a protected path;
determining the existence of an actionable condition;
accessing information on the first switch by referencing the operational state of the first network switch, the operational state of the second network switch, and the actionable condition; and
changing the operational state of the first switch based upon the information associated with the operational state of the first network switch, operational state of the second network switch, and the actionable condition.

2. The method of claim 1, wherein accessing information on the first switch further comprises accessing a table containing the information, the table indexed by at least the operational states of the first network switch and the second network switch.

3. The method of claim 1, further comprising:
determining the revertive mode of the first network switch; and
determining the revertive mode of the second network switch;
wherein:
accessing the information further comprises referencing the revertive mode of the first network switch and the revertive mode of the second switch; and
changing the operational state of the first switch is further based upon the revertive mode of the first network switch and the revertive mode of the second network switch.

4. The method of claim 1, wherein changing the operational state of the first network switch comprises changing the revertive configuration of the first network switch.

5. The method of claim 4, wherein the revertive configuration of the first network switch is changed if the revertive configuration of the first network switch and the revertive configuration of the second network switch are not the same.

6. The method of claim 1, wherein the operational state comprises a state defined in G.8031.

7. The method of claim 1, further comprising setting a standing condition based upon the information associated with the operational state of the first network switch, operational state of the second network switch, and the actionable condition.

8. The method of claim 1, further comprising moving user traffic between a protect path and a working path based upon the information associated with the operational state of the first network switch, operational state of the second network switch, and the actionable condition.

9. An article of manufacture comprising:
a computer readable medium; and
computer-executable instructions carried on the computer readable medium, the instructions readable by a processor, the instructions, when read and executed, for causing the processor to:
determine the operational state of a first network switch;
determine the operational state of a second network switch, the second network switch coupled to the first network switch by a protected path;
determine the existence of an actionable condition;
access information on the first network switch by referencing the operational state of the first network switch, the operational state of the second network switch, and the actionable condition; and
change the operational state of the first switch based upon the information associated with the operational state of the first network switch, operational state of the second network switch, and the actionable condition.

10. The article of claim 9, wherein accessing information on the first switch further comprises accessing a table containing the information, the table indexed by at least the operational states of the first network switch and the second network switch.

11. The article of claim 9, further comprising causing the processor to:
determine the revertive mode of the first network switch; and
determine the revertive mode of the second network switch;
wherein:
accessing the information further comprises referencing the revertive mode of the first network switch and the revertive mode of the second switch; and
changing the operational state of the first switch is further based upon the revertive mode of the first network switch and the revertive mode of the second network switch.

12. The article of claim 9, wherein changing the operational state of the first network switch comprises changing the revertive configuration of the first network switch.

13. The article of claim 12, wherein the revertive configuration of the first network switch is changed if the revertive configuration of the first network switch and the revertive configuration of the second network switch are not the same.

14. The article of claim 9, wherein the operational state comprises a state defined in G.8031.

15. The article of claim 9, further comprising causing the processor to set a standing condition based upon the information associated with the operational state of the first network switch, operational state of the second network switch, and the actionable condition.

16. The article of claim 9, further comprising causing the processor to move user traffic between a protect path and a working path based upon the information associated with the operational state of the first network switch, operational state of the second network switch, and the actionable condition.

17. A switch, the switch comprising:
a computer readable medium;
a transitional table stored in the computer readable medium;
a processor coupled to the computer readable medium;
computer-executable instructions carried on the computer readable medium, the instructions readable by the processor, the instructions, when read and executed, for causing the processor to:
determine the operational state of the switch;
determine the operational state of a far-end network switch coupled to the switch by a protected path;
determine the existence of an actionable condition;
access information in the transitional table by referencing the operational state of the switch, the operational state of the far-end network switch, and the actionable condition; and
change the operational state of the switch based upon the information in the transitional table associated with the operational state of the switch, the operational state of the far-end network switch, and the actionable condition.

18. The switch of claim 17, wherein the table is indexed by at least the operational states of the switch and the far-end network switch.

19. The switch of claim 17, further comprising instructions causing the processor to:
determine the revertive mode of the first network switch; and
determine the revertive mode of the second network switch;
wherein:
accessing the information further comprises referencing the revertive mode of the first network switch and the revertive mode of the second switch; and
changing the operational state of the first switch is further based upon the revertive mode of the first network switch and the revertive mode of the second network switch.

20. The switch of claim 17, wherein changing the operational state of the switch comprises changing the revertive configuration of the switch.

21. The switch of claim 20, wherein the revertive configuration of the switch is changed if the revertive configuration of the switch and the revertive configuration of the far-end network switch are not the same.

22. The switch of claim 17, wherein the operational state comprises a state defined in G.8031.

23. The switch of claim 17, further comprising causing the processor to set a standing condition based upon the information associated with the operational state of the switch, operational state of the far-end network switch, and the actionable condition.

24. The switch of claim 17, further comprising causing the processor to move user traffic between a protect path and a working path based upon the information associated with the operational state of the switch, operational state of the far-end network switch, and the actionable condition.
